(19) United States
(12) Patent Application Publication
(10) Pub. No.: US 2025/0390628 A1
(43) Pub. Date: Dec. 25, 2025

(54) SYSTEM AND METHOD FOR DETERMINING AN INFRASTRUCTURE ARRANGEMENT PATH

(71) Applicant: Centre for Intelligent Multidimensional Data Analysis Limited, Pak Shek Kok (HK)

(72) Inventors: Xinyu Wang, Pak Shek Kok (HK); Fahan Chen, Pak Shek Kok (HK); Zengfu Wang, Pak Shek Kok (HK); Tianjiao Wang, Pak Shek Kok (HK); William Moran, Pak Shek Kok (HK); Moshe Zukerman, Pak Shek Kok (HK)

(21) Appl. No.: 18/750,200

(22) Filed: Jun. 21, 2024

(51) Int. Cl. G06F 30/18

(52) U.S. Cl. CPC G06F 30/18

(57) ABSTRACT

A computer-implemented method for determining an infrastructure arrangement path. The method includes obtaining a path for arranging an infrastructure from a first geographic location to a second geographic location in a geographic region, determining that the path comprises a first path portion that defines a turn exceeding a turning limit associated with the infrastructure, and modifying the first path portion based on the turning limit to obtain a modified first path portion. The modified first path portion defines a modified turn not exceeding the turning limit and less sharp than the turn. The method further includes obtaining, based on the modified first path portion, a modified path for arranging the infrastructure from the first geographic location to the second geographic location.

### TECHNICAL FIELD

This invention relates to system and method for determining a path for arranging an infrastructure.

### BACKGROUND

Infrastructures such as electricity, oil, gas, telecommunications, transportation, and water infrastructures are essential to the functioning of modern economies and societies. In particular, trans-regional, trans-national, and trans-continental infrastructures often play a crucial role in transporting critical resources or information between two or more locations.

There is a need to reliably determine a suitable path for arranging an infrastructure in real-world, e.g., to facilitate infrastructure path planning and subsequent arrangement (e.g., construction) of the infrastructure.

### SUMMARY OF THE INVENTION

Embodiments of the invention can provide a practical tool, in particular a computer-implemented tool, which can be used to determine an infrastructure arrangement path.

In a first aspect, there is provided a computer-implemented method for determining an infrastructure arrangement path. The computer-implemented method comprises obtaining a path (a virtual path or route) for arranging an infrastructure from a first geographic location to a second geographic location in a geographic region, determining that the path comprises a first path portion that defines a turn exceeding a turning limit associated with the infrastructure, and modifying the first path portion based at least in part on the turning limit to obtain a modified first path portion. The modified first path portion defines a modified turn not exceeding the turning limit and less sharp than the turn. The computer-implemented method further comprises obtaining, based at least in part on the modified first path portion, a modified path for arranging the infrastructure from the first geographic location to the second geographic location.

By modifying the first path portion, which defines a sharper turn exceeding a turning limit associated with the infrastructure, to obtain the modified first path portion, which defines a less-sharp turn not exceeding the turning limit associated with the infrastructure, and obtaining the modified path based at least in part on the modified first path portion, the modified path obtained can provide a more useful path for arranging the infrastructure in real-world. In one example, the modified path can facilitate infrastructure arrangement path planning. In one example, the modified path can facilitate the arranging of the infrastructure from the first geographic location to the second geographic location in real-world.

In one example, part of the path is identical to part of the modified path.

The path may include one or more path portions that respectively defines a turn exceeding the turning limit. The computer-implemented method may be performed to modify any of the one or more path portions. In one example, the path includes two or more path portions that respectively defines a turn exceeding the turning limit, and the computer-implemented method is performed to modify each of the path portions, to obtain a modified path that does not include any path portion exceeding the turning limit associated with the infrastructure.

The infrastructure may include road, railway, bridge, tunnel, power line, data line, pipeline, etc.

Optionally, the infrastructure comprises a submarine infrastructure. The submarine infrastructure may include a submarine cable or a submarine pipeline. The submarine cable may include a power cable, a data/communication cable (e.g., optical fiber cable), or their combination. The submarine pipelines may include a pipeline for transporting liquid (e.g., oil, water, petrol, chemicals, etc.) or gas (e.g., natural gas, etc.).

In one example, the infrastructure comprises a submarine cable. In this example, arranging the infrastructure comprises laying the submarine cable, and the turning limit associated with the infrastructure may include a limit associated with a bending stiffness of the submarine cable and/or a limit associated with a maneuvering capability of a cable laying vehicle (e.g., vessel) for laying the submarine cable.

Optionally, the geographic region is categorized into a first type of region suitable for arranging the infrastructure and a second type of region not suitable for arranging the infrastructure. For example, the first type of region may be a type of region in which the arranging of the infrastructure is allowed (e.g., practically possible) or preferred; and the second type of region may be a type of region in which the arranging of the infrastructure is prohibited (e.g., practically impossible) or not preferred. Preferably, the path and the modified path are each respectively arranged entirely in the first type of region.

The first path portion may be an angled (sharp) portion or a curved portion. Optionally, the first path portion comprises a first straight path portion extending in a first direction and a second straight path portion extending in a second direction different from the first direction. In one example, the first and second directions are perpendicular. In one example, the first path portion consists only of the first and second straight path portions.

Optionally, the modified first path portion comprises a curved path portion with one end extending in the first direction and another end extending in the second direction. In one example, the modified first path portion consists only of the curved path portion. The curved path portion may be an arc-shaped portion. For example, arc-shaped portion may be shaped as a circular arc, an elliptical arc, or a parabolic arc.

Optionally, the computer-implemented method further comprises, prior to modifying the first path portion, determining whether the first path portion is adjacent (e.g., the first path portion is along the boundary of or is within a certain distance from the boundary of) the second type of region, and the modifying of the first path portion is further based at least in part on the determining of whether the first path portion is adjacent the second type of region.

Optionally, the computer-implemented method further comprises, prior to modifying the first path portion, determining that the first path portion is not adjacent (e.g., the first path portion is not along the boundary of or not within a certain distance from the boundary of) the second type of region. In one example of this case, modifying the first path portion comprises replacing at least part of the first straight path portion and at least part of the second straight path portion with the curved path portion.

Optionally, replacing at least part of the first straight path portion and at least part of the second straight path portion with the curved path portion comprises: replacing at least part of the first straight path portion and at least part of the second straight path portion with a first curved path portion (or an initial curved path portion); determining whether any part of the first curved path portion is in the second type of region; if any part of the first curved path portion is determined to be in the second type of region, modifying a shape or curvature of the first curved path portion to obtain a modified first curved path portion (or a subsequent curved path portion) that is entirely in the first type of region and providing the modified first curved path portion as the curved path portion; and if the first curved path portion is determined to be entirely in the first type of region, providing the first curved path portion as the curved path portion.

Optionally, the computer-implemented method further comprises, prior to modifying the first path portion, determining that the first path portion is adjacent the second type of region. In one example of this case, modifying the first path portion comprises: replacing the first path portion with a second path portion arranged further away from the second type of region, the second path portion defining a turn and comprising a third straight path portion parallel to and spaced apart from the first straight path portion and a fourth straight path portion parallel to and spaced apart from the second straight path portion; and replacing at least part of the third straight path portion and at least part of the fourth straight path portion with the curved path portion. The first and third straight path portions are spaced apart by a first perpendicular distance and the second and fourth straight path portions are spaced apart by a second perpendicular distance. In one example, the first and second perpendicular distances are the same. In one example, the first and second perpendicular distances are different. In one example, replacing at least part of the third straight path portion and at least part of the fourth straight path portion with the curved path portion may include: replacing at least part of the third straight path portion and at least part of the fourth straight path portion with a first curved path portion; determining whether any part of the first curved path portion is in the second type of region associated with the modified categorization of the geographic region; if any part of the first curved path portion is determined to be in the second type of region associated with the modified categorization of the geographic region, modifying a shape or curvature of the first curved path portion to obtain a modified first curved path portion that is entirely in the first type of region associated with the modified categorization of the geographic region and providing the modified first curved path portion as the curved path portion; and if the first curved path portion is determined to be entirely in the first type of region associated with the modified categorization of the geographic region, providing the first curved path portion as the curved path portion.

Optionally, the computer-implemented method further comprises, prior to modifying the first path portion, determining that the first path portion is adjacent the second type of region. In one example of this case, modifying the first path portion comprises: modifying the categorization of the geographic region to expand the second type of region such that at least part of (e.g., the entire) the first path portion is within the second type of region; performing a path determination operation based at least in part on the modified categorization of the geographic region to determine another path for arranging the infrastructure from the first geographic location to the second geographic location, the another path is arranged entirely in the first type of region associated with the modified categorization of the geographic region and comprises a second path portion defining a turn; and modifying the second path portion to obtain the modified first path portion. Optionally, the second path portion comprises a third straight path portion parallel to and spaced apart from the first straight path portion and a fourth straight path portion parallel to and spaced apart from the second straight path portion; and modifying the second path portion comprises replacing at least part of the third straight path portion and at least part of the fourth straight path portion with the curved path portion. In one example, replacing at least part of the third straight path portion and at least part of the fourth straight path portion with the curved path portion may include: replacing at least part of the third straight path portion and at least part of the fourth straight path portion with a first curved path portion; determining whether any part of the first curved path portion is in the second type of region associated with the modified categorization of the geographic region; if any part of the first curved path portion is determined to be in the second type of region associated with the modified categorization of the geographic region, modifying a shape or curvature of the first curved path portion to obtain a modified first curved path portion that is entirely in the first type of region associated with the modified categorization of the geographic region and providing the modified first curved path portion as the curved path portion; and if the first curved path portion is determined to be entirely in the first type of region associated with the modified categorization of the geographic region, providing the first curved path portion as the curved path portion.

In one example, obtaining the path comprises performing a path determination operation based at least in part on the categorization of the geographic region to determine the path for arranging the infrastructure. The path determination operation may be a path optimization operation and the path may be an optimal path. In one example, obtaining the path comprises retrieving the path that has already been determined by the path determination operation.

Optionally, the path determination operation (for obtaining the path and/or for obtaining the another path) comprises: obtaining a model associated with a geographic terrain of the geographic region and minimizing an objective function based at least in part on the model. The objective function may be established based at least in part on factors affecting cost for arranging the infrastructure in the geographic region. The path determination operation further comprises determining, based at least in part on minimizing the objective function, the path for arranging the infrastructure.

For example, obtaining the model associated with the geographic terrain of the geographic region may include building the model based at least in part on geographic terrain information (e.g., longitude, latitude, and elevation information) of the geographic region.

In one example, the model comprises a triangulated two-dimensional (2D) manifold model with a plurality of points. Each of the plurality of points may be respectively associated with a geographic location in the geographic region and may be respectively representable by a three-dimensional (3D) coordinate. The 3D coordinate may include longitude, latitude, and elevation information.

In one example, the objective function is associated with a total life cycle cost of the infrastructure. For example, the objective function may be defined based at least in part on

$${\sum }_{k = 1}^{K} {w}_{k} {c}_{k}$$

where cₖ is a cost factor attributed to a k^{th} consideration associated with arranging the infrastructure, wₖ is a weight factor, and K is an integer greater than or equal to 1. For example, the consideration associated with arranging the infrastructure may include any of: a construction cost consideration, a geological hazard consideration, a seabed slope consideration, a water depth consideration, an anthropological hazard consideration, or a protected regions consideration.

Optionally, minimizing the objective function comprises applying a Fast Marching Method (FMM) to minimize the objective function. In one example in this case, determining the path for arranging the infrastructure comprises: determining, based at least in part on minimizing the objective function, a plurality of Pareto optimal solutions representing a plurality of optimal paths each for arranging the infrastructure from the first geographic location to the second geographic location; and determining the path for arranging the infrastructure based at least in part on the plurality of optimal paths. In one example, the path is one of the plurality of optimal paths. In one example, the path is obtained based on one or more of the plurality of optimal paths.

Optionally, the computer-implemented method further comprises outputting the modified path for presentation (e.g., display). In one example, the modified path and/or the path may be overlaid onto the model associated with the geographic terrain of the geographic region for presentation.

In a second aspect, there is provided a system comprising a processor and memory storing a computer program configured to be executed by the processor. The computer program comprises instructions for performing or facilitating performing of the computer-implemented method of the first aspect. Optionally, the system further comprises a display for displaying the model associated with the geographic terrain of the geographic region, the modified path, and/or the path.

In a third aspect, there is provided a carrier medium carrying computer readable instructions arranged to cause a computer to perform or facilitate performing of the computer-implemented method of the first aspect. In one example, the carrier medium comprises a computer-readable medium. In one example, the computer-readable medium is a non-transitory computer-readable storage medium, which stores a computer program configured to be executed by a computer. The computer program comprises instructions for performing or facilitating performing of the computer-implemented method of the first aspect.

In a fourth aspect, there is provided a computer program comprising instructions which, when the program is executed by a computer, cause the computer to carry out the computer-implemented method of the first aspect.

In a fifth aspect, there is provided a method comprising: performing the computer-implemented method of the first aspect to obtain the modified path, and arranging the infrastructure in the geographic region from the first geographic location to the second geographic location according to the modified path. In one example, arranging the infrastructure comprises building or constructing the infrastructure in the geographic region.

Other features and aspects will become apparent by consideration of the following detailed description and the accompanying drawings. Any feature(s) described herein in relation to one aspect or embodiment may be combined with any other feature(s) described herein in relation to any other aspect or embodiment, as appropriate and applicable.

As used herein, unless otherwise specified, terms of degree such that “generally”, “about”, “substantially”, or the like, are intended to account for manufacture tolerance, degradation, trend, tendency, imperfect practical condition(s), etc. Also, unless otherwise specified, the terms “connected”, “coupled”, “mounted” or the like used herein are intended to encompass both direct and indirect connection, coupling, mounting, etc.

### BRIEF DESCRIPTION OF THE DRAWINGS

Some embodiments of the invention will now be described, with reference to the accompanying drawings, in which:

FIG. 1 is a flowchart illustrating a method for determining an infrastructure arrangement path in one embodiment of the invention;

FIG. 2 is a flowchart illustrating a method for determining an infrastructure arrangement path in one embodiment of the invention;

FIG. 3A is a schematic diagram illustrating modification of a path portion of an infrastructure arrangement path in one embodiment of the invention;

FIG. 3B is a schematic diagram illustrating modification of a path portion of an infrastructure arrangement path in an example useful for understanding the invention;

FIG. 3C is a schematic diagram illustrating modification of a path portion of an infrastructure arrangement path in one embodiment of the invention;

FIG. 4A is a picture illustrating a geographic region;

FIG. 4B is a picture illustrating earthquake-related information in the geographic region;

FIG. 4C is a picture illustrating coral reefs region in the geographic region;

FIG. 4D is a picture illustrating prohibited region in the geographic region;

FIG. 5A is a schematic diagram illustrating an infrastructure arrangement path in the geographic region;

FIG. 5B is a schematic diagram illustrating modification of a path portion of the infrastructure arrangement path shown in FIG. 5A;

FIG. 5C is a schematic diagram illustrating modification of another path portion of the infrastructure arrangement path shown in FIG. 5A;

FIG. 5D is a schematic diagram illustrating modification of the path portion of the infrastructure arrangement path shown in FIG. 5A; and

FIG. 6 is a block diagram illustrating an example information handling system that is operable to perform the method in some embodiments of the invention.

### DETAILED DESCRIPTION OF THE PREFERRED EMBODIMENTS

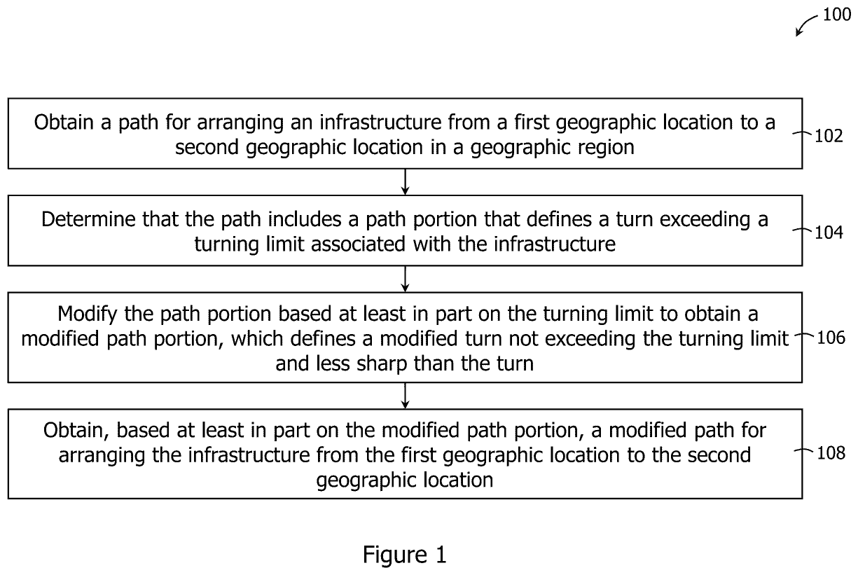

FIG. 1 illustrates a method 100 for determining an infrastructure arrangement path in one embodiment of the invention. The method 100 is a computer-implemented method. In this embodiment, the infrastructure may include a submarine infrastructure such as a submarine cable or a submarine pipeline.

The method 100 includes, in operation 102, obtaining a path for arranging an infrastructure from a first geographic location to a second geographic location in a geographic region. In one example in which the infrastructure includes a submarine cable, the path for arranging the infrastructure is a path for laying the submarine cable.

In one example, operation 102 may include determining the path by performing a path determination operation. In another example, operation 102 may include retrieving or receiving a path that has been already determined (e.g., by performing the path determination operation).

The path determination operation may include obtaining (e.g., building or retrieving or receiving) a model associated with a geographic terrain of the geographic region, minimizing an objective function based at least in part on the model, and determining, based at least in part on minimizing the objective function, the path for arranging the infrastructure. The objective function may be established based at least in part on factors (e.g., cost and/or risk factors) affecting cost for arranging the infrastructure in the geographic region. The model may be built based at least in part on geographic terrain information (e.g., longitude, latitude, and elevation information) of the geographic region. In one example, the model is a triangulated two-dimensional (2D) manifold model with multiple points each respectively associated with a geographic location in the geographic region and each respectively representable by a three-dimensional (3D) coordinate. In one example, the objective function is associated with a total life cycle cost of the infrastructure. For example, the objective function may be defined based at least in part on

$${\sum }_{k = 1}^{K} {w}_{k} {c}_{k}$$

where cₖ is a cost factor attributed to a k^{th} consideration associated with arranging the infrastructure, wₖ is a weight factor, and K is an integer greater than or equal to 1. For example, the consideration associated with arranging the infrastructure may include a construction cost consideration, a geological hazard consideration, a seabed slope consideration, a water depth consideration, an anthropological hazard consideration, a protected regions consideration, or any of their combination. The objective function may be minimized by applying a Fast Marching Method (FMM) or an equivalent or like method. Determining the path may include determining, based at least in part on minimizing the objective function, two or more Pareto optimal solutions (a Pareto front) representing optimal paths each for arranging the infrastructure from the first geographic location to the second geographic location, and then determining the path for arranging the infrastructure based at least in part on the optimal paths. For example, the path may be one of the optimal paths or may be otherwise based on one or more of the optimal paths.

The method 100 includes, in operation 104, determining that the path includes a path portion that defines a turn exceeding a turning limit associated with the infrastructure. In one example in which the infrastructure includes a submarine cable, the turning limit associated with the infrastructure may include a limit associated with a bending stiffness of the submarine cable and/or a limit associated with a maneuvering capability of a cable laying vehicle (e.g., vessel) for laying the submarine cable. In one example, operation 104 can be performed using computer-vision based technique (e.g., by analyzing an image containing the path). In one example, operation 104 can be performed using algorithm operable to track and/or identify the turn(s) of the path.

The method 100 includes, in operation 106, modifying the path portion based at least in part on the turning limit to obtain a modified path portion. The modified path portion defines a modified turn not exceeding the turning limit and less sharp than the turn.

The path portion may be an angled (sharp) portion or a curved portion, and the modified path portion may be a curved portion. In one example, the path portion is formed by two straight path portions extending in two different directions. In one example, the modified path portion is formed by a curved path portion with one end extending in one of the two different directions and another end extending in another one of the two different directions. The curved path portion may be an arc-shaped portion. For example, arc-shaped portion may be shaped as a circular arc, an elliptical arc, or a parabolic arc.

Operation 106 may be performed based on predetermined curve shapes and optionally associated scaling parameters. For example, operation 106 may be performed based on predetermined circular-arc-shaped curves with different radii. For example, operation 106 may include replacing at least part of the path portion with a replacement path portion having a predetermined shape and/or curvature. The replacing may be performed once, or multiple times (e.g., iteratively), until a suitable path portion that does not exceed the turning limit (and optionally meeting one or more other requirement(s)) is identified.

The method 100 includes, in operation 108, obtaining, based at least in part on the modified path portion, a modified path for arranging the infrastructure from the first geographic location to the second geographic location. As such, the modified path may include the modified path portion which does not exceed the turning limit associated with the infrastructure. In one example, part of the modified path may be the same as the path (the unmodified path).

In one embodiment, the geographic region is categorized into a first type of region suitable for arranging the infrastructure and a second type of region not suitable for arranging the infrastructure, and both the path and the modified path are each respectively arranged entirely in the first type of region. In one embodiment, prior to modifying the path portion, the method 100 includes determining whether the path portion is adjacent the second type of region, and operation 106 is further based at least in part on whether the path portion is adjacent the second type of region. In one example, if the path portion is not adjacent the second type of region, operation 106 may include replacing the path portion with the modified path portion without moving the path portion. In one example, if the path portion is adjacent the second type of region, operation 106 may include moving the path portion and replacing the moved path portion with the modified path portion.

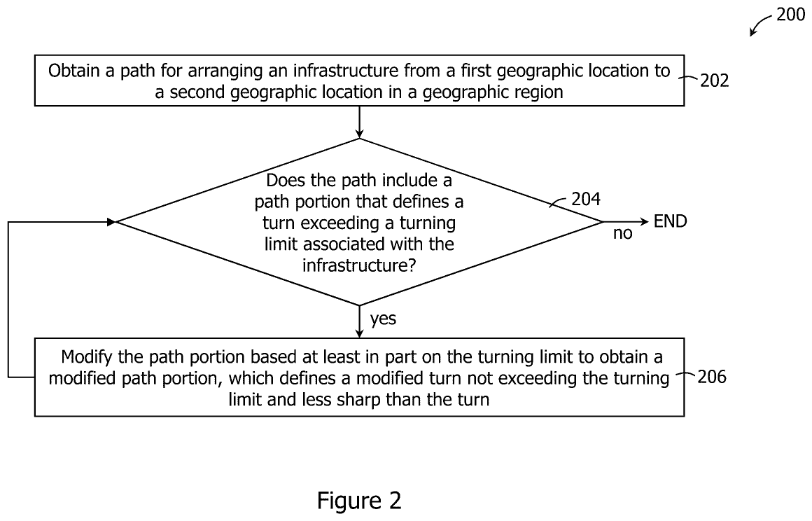

FIG. 2 illustrates a method 200 for determining an infrastructure arrangement path in one embodiment of the invention. The method 200 is a computer-implemented method and it can be considered as an example of method 100.

The method 200 includes, in operation 202, obtaining a path for arranging an infrastructure from a first geographic location to a second geographic location in a geographic region. Operation 202 may be similar to or the same as operation 102 (hence details will not be repeated here).

The method 200 includes, in operation 204, determining whether the path include a path portion that defines a turn exceeding a turning limit associated with the infrastructure. The operation 204 may be performed using computer-vision based technique and/or an algorithmic technique.

If, in operation 204, it is determined that the path does not include a path portion that defines a turn exceeding a turning limit associated with the infrastructure, then method 200 terminates and the path is not modified.

If, in operation 204, it is determined that the path includes a path portion that defines a turn exceeding a turning limit associated with the infrastructure, then method 200 proceeds to operation 206, to modify the path portion based at least in part on the turning limit to obtain a modified path portion. The modified path portion defines a modified turn not exceeding the turning limit and less sharp than the turn of the path portion. Operation 206 may be similar to or the same as operation 106 (hence details will not be repeated here).

After operation 206, the method 200 may return to operation 204, to determine whether the path includes any further path portion that defines a turn exceeding a turning limit associated with the infrastructure. If, in operation 204, it is determined that the path does not include any further path portion that defines a turn exceeding a turning limit associated with the infrastructure, then method 200 terminates. If, in operation 204, it is determined that the path includes a further path portion that defines a turn exceeding a turning limit associated with the infrastructure, then method 200 again proceeds to operation 206, to modify the further path portion based at least in part on the turning limit to obtain a further modified path portion. Operations 204 and 206, may repeat until the modified path no longer includes any path portion that defines a turn exceeding a turning limit associated with the infrastructure.

The modified path obtained by method 200 would therefore not include any path portion that defines a turn exceeding a turning limit associated with the infrastructure.

A more-specific example embodiment of the invention is now presented. This more-specific example embodiment relates to submarine cable path planning with curvature constraints.

Inventors of the present invention have found, through their research, that submarine optical fiber cables for transmitting data are indispensable to the global information infrastructure, and that the intricate process of planning these submarine cable paths entails determining an optimal (e.g., the most efficient path) between two or more specified locations taking into account various hydrogeological and anthropogenic factors (such as earthquakes, volcanic eruptions, water depth, seabed slope, sediment hardness, marine protected regions, activities related to fishing and anchoring, etc.).

Inventors of the present invention have found that the existing industry standard for submarine cable path planning involves predominantly manual path planning. Inventors of the present invention have further found that an existing tool used for assisting path planning, MakaiPlan, does not automate the optimization of cable routes and instead calculates the shortest path along the Great Circle as a series of Rhumb lines, and this initially calculated shortest path needs to be manually adjusted to mitigate costs associated with various risks. Inventors of the present invention believe that given the extensive lengths of long-haul cables, which can span thousands of kilometers, the predominance of manual path planning (without scalable and automated methods) might not effectively balance cost against risk.

Inventors of the present invention have found that while some research works exist in this technical field (e.g., research related to models and analyses concerning cable systems and networks, research related to FMM-based optimization techniques for submarine cable path planning, and research related to point-to-point cable path planning and cable system optimization), a critical aspect overlooked by these research works is cable bending fitness. In practice, when laying cables, curvatures (turns) are inevitable due to the need to circumvent obstacles, necessitating that the curvature radius does not exceed the bending radius limitations of the cable. Inventors of the present invention have noted that existing path planning methods typically require manual adjustments for smoothing the path, which may lead to suboptimal paths. Inventors of the present invention have found that while the FMM is a precise numerical approach capable of solving the Eikonal equation and can offer a viable, rigorous, and efficient alternative by optimizing the path between a source and a destination taking into account a summary objective function of costs and risk factors, the implementation of FMM-based techniques often neglects the crucial curvature constraints arising from the flexural rigidity of cables and maneuvering capabilities of the laying vessels in real-world.

Against this background, inventors of the present invention have provided, in this embodiment, a method, in particular a computer-implemented method, that can effectively address bending challenges in submarine cable path planning. In this embodiment, by expanding forbidden regions and smoothing sharp turns into circular arcs of predefined radii, the method can determine submarine cable path that complies with curvature constraints, ensuring robust and practical routing solutions.

In the method of this embodiment, a modeling technique is applied. In particular, in this embodiment, a triangulated piecewise-linear 2D manifold M in a 3D domain D is used to represent the Earth's surface. Specifically, every point on M is assigned to a three-dimensional coordinate (x, y, z) where x and y are the longitude and latitude of this point, and z=ξ(x, y) is the elevation of point (x, y). Further details can be found, e.g., in Wang et al., “Cost-effective path planning for submarine cable network extension” (2019) and in Wang et al., “Submarine cable path planning based on weight selection of design considerations” (2021), the entire contents of these two publications are incorporated herein by reference in their entirety.

In this embodiment, a life-cycle cost model that incorporates multiple considerations that impact both the costs and the survivability of submarine cables is employed. The model provides a thorough representation of their cost-efficiency and longevity. Assuming a set of K design considerations associated with anthropogenic activities or hydrogeological risks, which could impact the durability and economic efficiency of the submarine cable, a non-negative set W={w₁, w₂, . . . , wₖ} is introduced, where wₖ denotes the significance of the k^{th} design factor in the cable path planning process. For a point X=(x, y, z)∈M,

$$C ( X ) = {\sum }_{k = 1}^{K} {w}_{k} {c}_{k} ( X )$$

can be used to represent the life-cycle cost per unit length for the cable at location X. Further details can be found, e.g., in Wang et al., “Cost-effective path planning for submarine cable network extension” (2019) and in Wang et al., “Submarine cable path planning based on weight selection of design considerations” (2021), the entire contents of these two publications have been incorporated herein by reference in their entirety.

In the method of this embodiment, curvature constraints associated with the submarine cable are considered. Specifically, the incorporation of critical curvature constraints stemming from the bending stiffness of the cables and the maneuvering capabilities of the laying vessel in realistic scenarios in considered and incorporated in the method of this embodiment. In this respect, two example cases are provided.

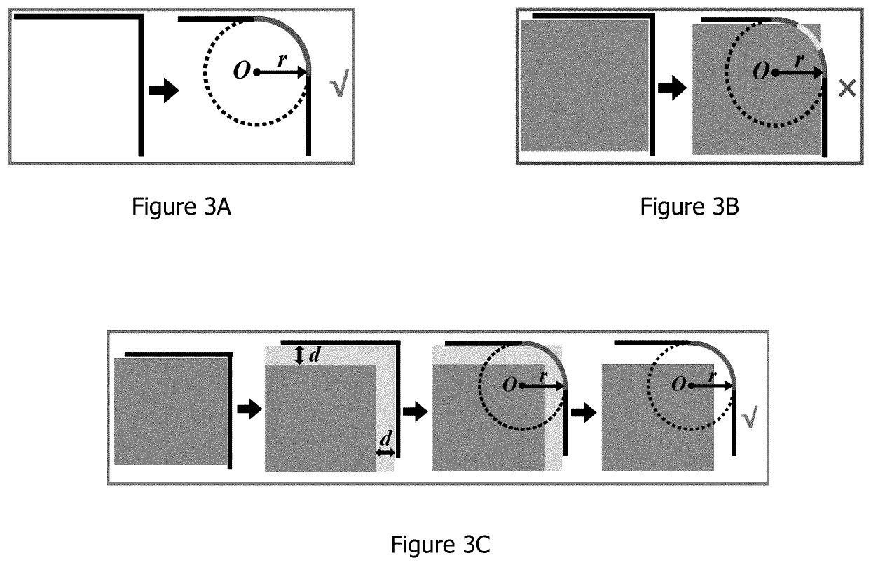

FIGS. 3A to 3C concern substituting sharp angled turn with circular arc. Specifically, FIG. 3A illustrates replacement of a sharp angled turn with a circular arc where no prohibited regions are present; FIG. 3B illustrates an infeasible direct sharp angled turn replacement (encroachment into a prohibited region); FIG. 3C illustrates the implementation of prohibited region expansion to facilitate substituting sharp angled turn with circular arc.

In the first example case, for a sharp, angled turn (a path portion defining a turn exceeding a turning limit associated with the submarine cable) not adjacent any prohibited regions (in which laying of the submarine cable is prohibited) as shown in FIG. 3A, the sharp, angled turn is replaced with a circular arc of a predefined radius r (a modified path portion defining a modified turn that does not exceed the turning limit and is less sharp than the turn of the path portion). The circular arc in FIG. 3A indicates the new path segment. In this example, a direct substitution is permissible as the modified path (with the circular arc) does not traverse any prohibited regions.

In the second example case, for a sharp, angled turn (a path portion defining a turn exceeding a turning limit associated with the submarine cable) adjacent a prohibited region (in which laying of the submarine cable is prohibited) as depicted in FIGS. 3B and 3C, direct replacement of the angled turn with a circular arc is infeasible because the circular arc may pass through or cross the prohibited region (FIG. 3B). To address this problem, in one example, the prohibited region (shaded) is gradually expanded until an appropriate expansion distance d is obtained and an expanded buffer (lightly shaded) is created. This adjustment is illustrated in FIG. 3C. A new path is then calculated based on the expanded prohibited region constraint and the circular arc transformation with radius r is applied for the new path. The prohibited region is then returned to its original shape and size, to ensure that the replacement of the sharp, angled turn with the circular arc having a predefined bending radius adheres to the curvature constraints and guarantees that the path does not pass through or cross any prohibited regions.

In more general terms, in the first example case, the method includes, prior to modifying the path portion (the sharp, angled turn), determining that the path portion is not adjacent the second type of region (which is not suitable for arranging the infrastructure), and modifying the path portion includes replacing at least part of each of the straight path portions associated with the path portion of the sharp, angled turn with the curved path portion (the circular arc). In one example, replacing at least part of each of the straight path portions associated with the path portion (the sharp, angled turn) with the curved path portion (the circular arc) includes: replacing at least part of each of the straight path portions associated with the path portion (the sharp, angled turn) with an initial curved path portion; determining whether any part of the initial curved path portion is in the second type of region; if any part of the first curved path portion is determined to be in the second type of region, modifying a shape or curvature of the initial curved path portion to obtain a subsequent curved path portion that is entirely in the first type of region (which is suitable for arranging the infrastructure) and providing the subsequent curved path portion as the curved path portion; and if the initial curved path portion is determined to be entirely in the first type of region, providing the initial curved path portion as the curved path portion.

In more general terms, in the second example case, the method includes, prior to modifying the path portion (the sharp, angled turn), determining that the path portion is adjacent the second type of region (which is not suitable for arranging the infrastructure), and modifying the path portion includes modifying the categorization of the geographic region to expand the second type of region such that entire path portion (the sharp, angled turn) is within the second type of region; performing a path determination operation based at least in part on the modified categorization of the geographic region to determine another path for arranging the infrastructure, the another path is arranged entirely in the first type of region associated with the modified categorization of the geographic region and comprises another path portion defining a turn, and modifying the another path portion to obtain the curved path portion (the circular arc). The another path portion may include two straight path portions, one parallel to and spaced apart from one of the straight path portions of the path portion (the sharp, angled turn) and another parallel to and spaced apart from another one of the straight path portions of the path portion (the sharp, angled turn). Modifying the another path portion may include replacing at least part of each of the two straight path portions of the another path portion with the curved path portion (the circular arc). Alternatively, in the second example case, the method includes prior to modifying the path portion (the sharp, angled turn), determining that the path portion is adjacent (e.g., the path portion is along the boundary of or is within a certain distance from the boundary of) the second type of region (which is not suitable for arranging the infrastructure), and modifying the path portion includes replacing the path portion with another path portion arranged further away from the second type of region (the another path portion defines a turn and may include two straight path portions, one parallel to and spaced apart from one of the straight path portions of the path portion and another parallel to and spaced apart from another one of the straight path portions of the path portion), and modifying the another path portion by replacing at least part of each of the two straight path portions of the another path portion with the curved path portion (the circular arc).

Turning now to the problem formulation in this embodiment. In this embodiment, the objective is to determine the most cost-effective submarine cable path that minimizes the total life cycle cost between two specified points, A and B. In one example, the objective function can be defined as follows:

$$∅ ( S ) = {min}_{α} C ( α ) = min {\int }_{l ( 0 )}^{l ( α )} C ( X ( s ) ) d s = min {\int }_{l ( 0 )}^{l ( α )} {\sum }_{k = 1}^{K} {w}_{k} {c}_{k} X ( s ) ds , \\ s . t . α ( 0 ) = A , α ( l ) = B \qquad ( 1 )$$

where l(α) represents the total length of the cable path a.

In one example, equation (1) can be reformulated into a nonlinear partial differential equation, specifically the Eikonal equation, which can be efficiently solved using FMM-based technique. Further details can be found, e.g., in Wang et al., “Submarine cable path planning based on weight selection of design considerations” (2021), the entire contents of which has been incorporated herein by reference in its entirety.

The method of this embodiment can be further demonstrated with an example.

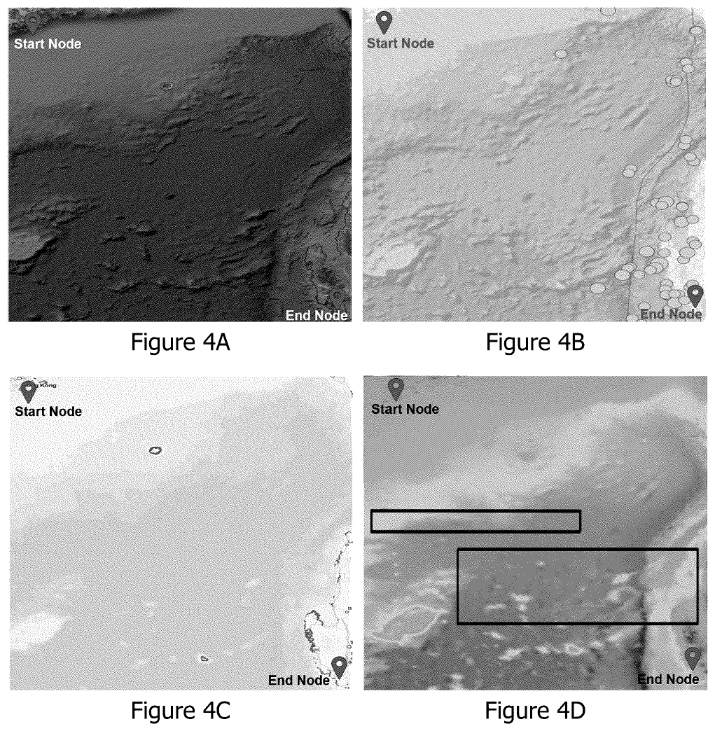

In this example, the method of this embodiment is demonstrated in region D that covers the South China Sea from (14°00′00″N, 113°00′00″E) to (23°00′00″N, 120°00′00″E), as shown in FIGS. 4A to 4D.

FIGS. 4A to 4D are various maps of region D. Specifically, FIG. 4A shows geography of region D in Google Earth; FIG. 4B shows earthquakes information (represented by gray circles) of region D (Source: United States Geological Survey); FIG. 4C shows coral reef regions in region D (Source: World Conservation Monitoring Centre); and FIG. 4D shows prohibited regions (represented by two rectangles) in region D.

In this example, the goal is to design a cable path from Hong Kong SAR at (22°10′52″N, 114°08′58″E) to Bayan ng Mariveles at (14°25′03″N, 120° 27′54″E), highlighted by pins (start node and end node) in FIGS. 4A to 4D. In this example, six design considerations, including basic construction cost, geological hazards, seabed slope, water depth, anthropological hazards, and protected regions, are considered. Details on the cost calculation and weights that can be used can be found, e.g., in Wang et al., “Submarine cable path planning based on weight selection of design considerations” (2021), the entire contents of which has been incorporated herein by reference in its entirety.

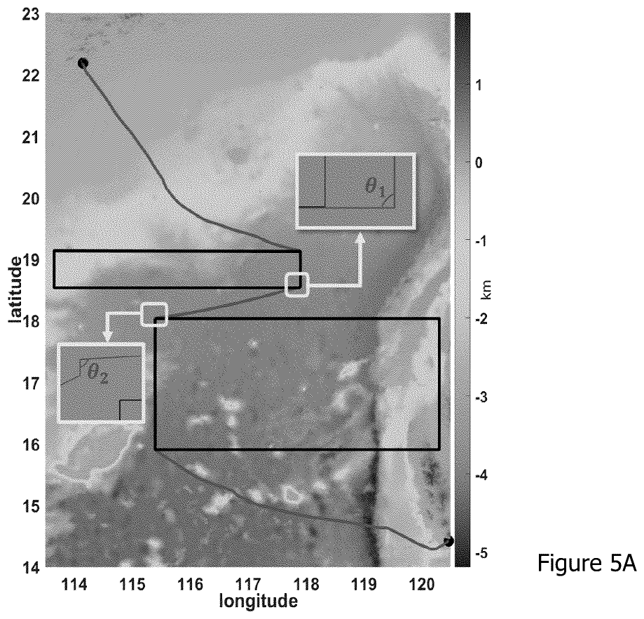

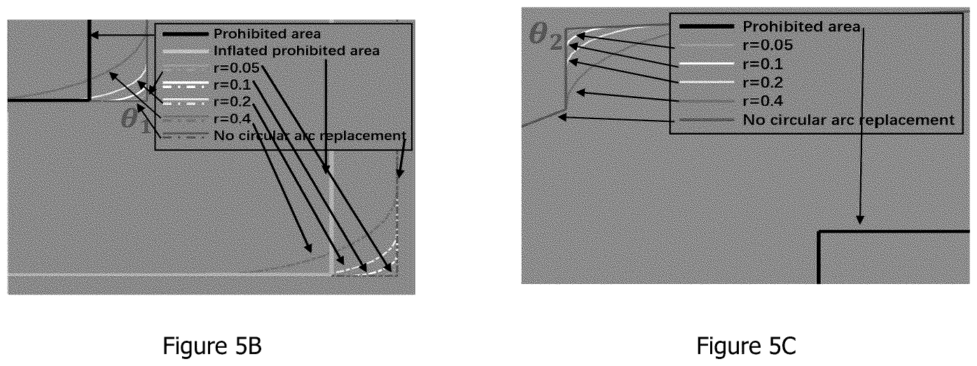

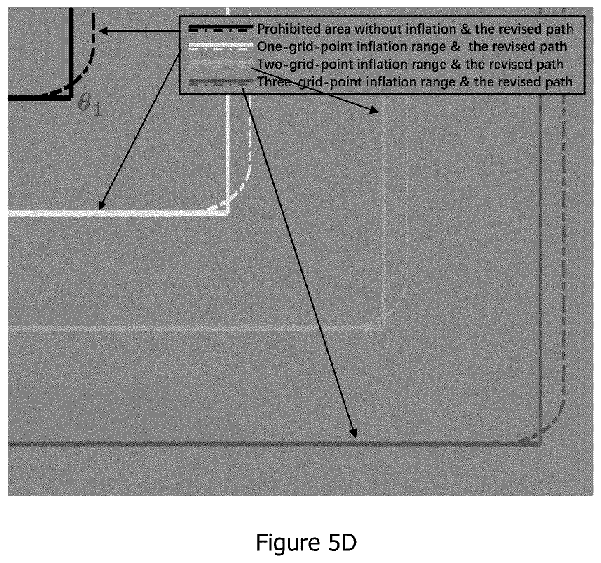

FIGS. 5A to 5D relate to cable path planning with curvature constraints. Specifically, FIG. 5A illustrates an initial (determined) cable path with sharp turns 01 and 02; FIGS. 5B and 5C illustrate path modifications using circular arcs with different radii and expanded prohibited areas; FIG. 5D illustrates path modifications using circular arcs replacement with r=0.4 km and different expanded prohibited areas.

As shown in FIG. 5A, in this example, under the influence of two prohibited regions, the FMM-generated cable path features two sharp turns, θ₁ and θ₂ (see the magnified sections in FIG. 5A). In FIG. 5B, attempts to replace these turns with circular arcs of different bending radii (denoted as r) reveal that revised paths with r=0.4 km and r=0.2 km intersect the prohibited region (marked by black lines). To address this, the prohibited region is expanded by one grid point before replacing the turns, to ensure that the modified paths for all values of r do not cross the original prohibited regions. For the sharp turn θ₂, direct replacement of the path segment with circular arcs with all tested radii do not intersect with the prohibited regions hence the expansion of the prohibited region is not required. The results in FIG. 5D concern an investigation on how the path modifications vary with different expansion ranges, and in this example, a bending radius of r=0.4 km is maintained for the circular arc replacement. It is observed that as the expansion range increases, although the path deviates further from the initially optimal FMM-generated path, it reduces the likelihood of the modified path with circular arcs intersecting the original prohibited regions, thus allowing for the use of larger bending radii to replace the sharp turn θ₂.

Table I below shows detailed numerical results for the paths in FIGS. 5A to 5D where d indicates the expansion range of prohibited regions (e.g., d=1 signifies a one-grid-point inflation).

TABLE I
Numerical results for the example paths in FIGS. 5A to 5D

| | | d = 1 | | | | | |
|---|---|---|---|---|---|---|---|
| | d = 0, | r = | r = | r = | r = | r = 0.4 km | |
| | r = 0 | 0.05 km | 0.1 km | 0.2 km | 0.4 km | d = 2 | d = 3 |
| Length (km) | 1707.4550 | 1710.4009 | 1710.3627 | 1710.2863 | 1710.1335 | 1713.2204 | 1715.8033 |
| Life-cycle cost | 47.8090 | 47.8912 | 47.8901 | 47.8880 | 47.8837 | 47.9701 | 48.0425 |
| (million $) | | | | | | | |

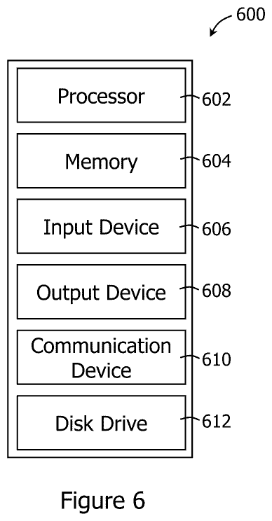

In summary, in this embodiment, there is provided a method for submarine optical fiber cable path planning that effectively and practically incorporates curvature constraints to meet real-world challenges such as cable bending stiffness and vessel maneuverability. By systematically (e.g., iteratively) expanding restricted regions and/or replacing sharp turns with predefined radius circular arcs, the method in this embodiment does not only ensure the practicality of the cable path planning algorithm but also enhances the reliability of the cable structure. Although the path obtained by using the method in this embodiment might slightly deviate from the originally determined optimal path calculated by FMM (which may result in a slight increase in cable length and total life-cycle cost), it offers a more practical solution for cable laying and can improve the survivability of submarine cable arranged according to such path. FIG. 6 shows an example information handling system 600 that can be used to perform the method in some embodiments of the invention. The information handling system 600 includes suitable components necessary to receive, store, and execute appropriate computer instructions, commands, and/or codes. In this example, the information handling system 600 includes a processor 602 and a memory (storage) 604. The processor 602 may include one or more of: CPU(s), MCU(s), GPU(s), NPU(s), VPU(s), TPU(s), logic circuit(s), Raspberry Pi chip(s), digital signal processor(s) (DSP), application-specific integrated circuit(s) (ASIC), field-programmable gate array(s) (FPGA), and digital and/or analog circuitry (or circuitries) configured to interpret program instructions, to execute program instructions, and/or to process signals and/or information and/or data. The memory 604 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data are stored in the memory 604. For example, computer instructions for executing or facilitating executing of the method embodiments of the invention may be stored in the memory 604. The processor 602 and memory 604 may be integrated or separated (and operably connected).

Optionally, the information handling system 600 further includes one or more input devices 606. Examples of an input device 606 include: keyboard, mouse, stylus, image scanner, microphone, tactile/touch input device (e.g., touch sensitive screen), image/video input device (e.g., camera), etc. Optionally, the information handling system 600 further includes one or more output devices 608. Examples of an output device 608 include: display (e.g., monitor, screen, projector, etc.), speaker, headphone, earphone, printer, additive manufacturing machine (e.g., 3D printer), etc. The display may include an LCD display, a LED/OLED display, or other suitable display, which may or may not be touch sensitive. The information handling system 600 may further include one or more disk drives 612 which may include one or more of: solid state drive, hard disk drive, optical drive, flash drive, magnetic tape drive, etc. A suitable operating system may be installed in the information handling system 600, e.g., on the disk drive 612 or in the memory 604. The memory 604 and the disk drive 612 may be operated by the processor 602. Optionally, the information handling system 600 also includes a communication device 610 for establishing one or more communication links with one or more other computing devices, such as servers, personal computers, terminals, tablets, phones, watches, IoT devices, or other wireless computing devices. The communication device 610 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, a cellular (2G, 3G, 4G, 5G, 6G, or the like) transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data. In one example, the processor 602, the memory 604 (optionally the input device(s) 606, the output device(s) 608, the communication device(s) 610 and the disk drive(s) 612, if present) are connected with each other, directly or indirectly, through a bus, a Peripheral Component Interconnect (PCI), such as PCI Express, a Universal Serial Bus (USB), an optical bus, or other like bus structure. In one embodiment, at least some of these components may be connected wirelessly, e.g., through a network, such as the Internet or a cloud computing network. A person skilled in the art appreciates that the information handling system 600 is merely an example and that in other embodiments the information handling system 600 can have a different configuration (e.g., with additional components, fewer components, alternative components, etc.).

Although not required, the embodiments described with reference to the Figures can be implemented as an application programming interface (API) or as a series of libraries for use by a developer or can be included within another software application, such as a terminal or computer operating system or a portable computing device operating system. Generally, as program modules include routines, programs, objects, components and data files assisting in the performance of particular function, the skilled person will understand that the functionality of the software application may be distributed across a number of routines, objects and/or components to achieve the same functionality desired herein.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include any appropriate arrangement of computer or information processing hardware capable of implementing the function described.

Embodiments of the invention can provide a practical software-based tool that can be used for infrastructure path planning.

In one specific example application, the tool can be used for submarine cable path planning, useful for determining suitable arrangement of optical fiber cables for telecommunications and data transfer. In some cases, the method may enhance the efficiency and reliability of submarine cable installations by offering a robust solution that optimally balances cost and structural integrity through adherence to essential curvature limitations. By ensuring that the path planning adheres to physical constraints, the method can also facilitate the laying of the cables in areas that were previously considered challenging or inaccessible, thereby potentially broadening the scope of global communication networks. In some cases, the method can reduce the risk of cable damage during both installation and operation, which in turn lowers maintenance costs and prolongs the lifespan of the cables. Moreover, the method can automate aspects of the path planning process, which could in turn lead to reduced labor costs and/or expedited deployment times.

The method may be used by practitioners in submarine cable design and construction. By employing the techniques outlined in this disclosure, cable path designers can more effectively plan and optimize cable paths with careful consideration of cable curvature, reducing cabling costs and improving network resilience. Application of the techniques in various embodiments of the invention is not confined to submarine cable path planning but can be applied to other sectors or in other applications, such as sections requiring intricate path planning, e.g., electrical cable networks, gas pipelines, transportation route planning, etc.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive.

While some of the embodiments described above relate to determination of a submarine cable path, the present invention can be applied to determining the arrangement path of other types of infrastructure such as road, railway, bridge, tunnel, power line, data line, pipeline, etc.

1. A computer-implemented method for determining an infrastructure arrangement path, comprising:
obtaining a path for arranging an infrastructure from a first geographic location to a second geographic location in a geographic region;
determining that the path comprises a first path portion that defines a turn exceeding a turning limit associated with the infrastructure;
modifying the first path portion based at least in part on the turning limit to obtain a modified first path portion, the modified first path portion defining a modified turn not exceeding the turning limit and less sharp than the turn; and
obtaining, based at least in part on the modified first path portion, a modified path for arranging the infrastructure from the first geographic location to the second geographic location.

2. The computer-implemented method of claim 1, wherein the infrastructure comprises a submarine infrastructure.

3. The computer-implemented method of claim 2,
wherein the submarine infrastructure comprises a submarine cable;
wherein arranging the infrastructure comprises laying the submarine cable; and
wherein the turning limit associated with the infrastructure comprises:
a limit associated with a bending stiffness of the submarine cable; and/or
a limit associated with a maneuvering capability of a cable laying vehicle for laying the submarine cable.

4. The computer-implemented method of claim 3,
wherein the geographic region is categorized into a first type of region suitable for arranging the infrastructure and a second type of region not suitable for arranging the infrastructure;
wherein the path is arranged entirely in the first type of region; and
wherein the modified path is arranged entirely in the first type of region.

5. The computer-implemented method of claim 4,
wherein the first path portion comprises a first straight path portion extending in a first direction and a second straight path portion extending in a second direction different from the first direction; and
wherein the modified first path portion comprises a curved path portion with one end extending in the first direction and another end extending in the second direction.

6. The computer-implemented method of claim 5, wherein the curved path portion is an arc-shaped portion.

7. The computer-implemented method of claim 6, further comprising:
prior to modifying the first path portion, determining whether the first path portion is adjacent the second type of region; and
wherein the modifying of the first path portion is further based at least in part on the determining of whether the first path portion is adjacent the second type of region.

8. The computer-implemented method of claim 7, further comprising:
prior to modifying the first path portion, determining that the first path portion is not adjacent the second type of region; and
wherein modifying the first path portion comprises:
replacing at least part of the first straight path portion and at least part of the second straight path portion with the curved path portion.

9. The computer-implemented method of claim 8, wherein replacing at least part of the first straight path portion and at least part of the second straight path portion with the curved path portion comprises:
replacing at least part of the first straight path portion and at least part of the second straight path portion with a first curved path portion;
determining whether any part of the first curved path portion is in the second type of region;
if any part of the first curved path portion is determined to be in the second type of region, modifying a shape or curvature of the first curved path portion to obtain a modified first curved path portion that is entirely in the first type of region and providing the modified first curved path portion as the curved path portion; and
if the first curved path portion is determined to be entirely in the first type of region, providing the first curved path portion as the curved path portion.

10. The computer-implemented method of claim 7, further comprising:
prior to modifying the first path portion, determining that the first path portion is adjacent the second type of region; and
wherein modifying the first path portion comprises:
replacing the first path portion with a second path portion arranged further away from the second type of region, the second path portion defining a turn and comprising a third straight path portion parallel to and spaced apart from the first straight path portion and a fourth straight path portion parallel to and spaced apart from the second straight path portion; and
replacing at least part of the third straight path portion and at least part of the fourth straight path portion with the curved path portion.

11. The computer-implemented method of claim 7, further comprising:
prior to modifying the first path portion, determining that the first path portion is adjacent the second type of region; and
wherein modifying the first path portion comprises:
modifying the categorization of the geographic region to expand the second type of region such that at least part of the first path portion is within the second type of region;
performing a path determination operation based at least in part on the modified categorization of the geographic region to determine another path for arranging the infrastructure from the first geographic location to the second geographic location, the another path is arranged entirely in the first type of region associated with the modified categorization of the geographic region and comprises a second path portion defining a turn; and
modifying the second path portion to obtain the modified first path portion.

12. The computer-implemented method of claim 11,
wherein the second path portion comprises a third straight path portion parallel to and spaced apart from the first straight path portion and a fourth straight path portion parallel to and spaced apart from the second straight path portion; and
wherein modifying the second path portion comprises replacing at least part of the third straight path portion and at least part of the fourth straight path portion with the curved path portion.

13. The computer-implemented method of claim 12,
wherein replacing at least part of the third straight path portion and at least part of the fourth straight path portion with the curved path portion comprises:
replacing at least part of the third straight path portion and at least part of the fourth straight path portion with a first curved path portion;
determining whether any part of the first curved path portion is in the second type of region associated with the modified categorization of the geographic region;
if any part of the first curved path portion is determined to be in the second type of region associated with the modified categorization of the geographic region, modifying a shape or curvature of the first curved path portion to obtain a modified first curved path portion that is entirely in the first type of region associated with the modified categorization of the geographic region and providing the modified first curved path portion as the curved path portion; and
if the first curved path portion is determined to be entirely in the first type of region associated with the modified categorization of the geographic region, providing the first curved path portion as the curved path portion.

14. The computer-implemented method of claim 13, wherein obtaining the path comprises performing a path determination operation based at least in part on the categorization of the geographic region to determine the path for arranging the infrastructure.

15. The computer-implemented method of claim 14, wherein the path determination operation comprises:
obtaining a model associated with a geographic terrain of the geographic region;
minimizing an objective function based at least in part on the model, the objective function being established based at least in part on factors affecting cost for arranging the infrastructure in the geographic region; and
determining, based at least in part on minimizing the objective function, the path for arranging the infrastructure.

16. The computer-implemented method of claim 15,
wherein the model comprises a triangulated two-dimensional (2D) manifold model with a plurality of points; and
wherein each of the plurality of points is respectively associated with a geographic location in the geographic region and is respectively representable by a three-dimensional (3D) coordinate.

17. The computer-implemented method of claim 16, wherein the objective function is associated with a total life cycle cost of the infrastructure.

18. The computer-implemented method of claim 17,
wherein minimizing the objective function comprises:
applying a Fast Marching Method (FMM) to minimize the objective function; and
wherein determining the path for arranging the infrastructure comprises:
determining, based at least in part on minimizing the objective function, a plurality of Pareto optimal solutions representing a plurality of optimal paths each for arranging the infrastructure from the first geographic location to the second geographic location; and
determining the path for arranging the infrastructure based at least in part on the plurality of optimal paths.

19. A system comprising:
one or more processors; and
memory storing a computer program configured to be executed by the one or more processors, the computer program comprising instructions for performing or facilitating performing of the computer-implemented method of claim 18.

20. A non-transitory computer-readable storage medium storing a computer program configured to be executed by a computer, the computer program comprising instructions for performing or facilitating performing of the computer-implemented method of claim 18.
